(19) United States
(12) Patent Application Publication
(10) Pub. No.: US 2026/0304442 A1
(43) Pub. Date: Oct. 1, 2026

(54) MECHANISM TO SUSPEND/RESUME RS RESOURCES IN RRC-INACTIVE

(71) Applicant: QUALCOMM Incorporated, San Diego, CA (US)

(72) Inventors: Alexandros MANOLAKOS, Athens (GR); Mukesh KUMAR, Hyderabad (IN)

(21) Appl. No.: 19/477,760

(22) PCT Filed: Jun. 4, 2024
(86) PCT No.: PCT/US2024/032368

§ 371 Date: Oct. 22, 2025

(30) Foreign Application Priority Data
Jun. 15, 2023 (IN) 202341040899

(51) Int. Cl. H04W 72/231; H04L 5/00; H04W 24/10; H04W 72/0446

(52) U.S. Cl. CPC H04W 72/231; H04L 5/0094; H04W 24/10; H04W 72/0446

(57) ABSTRACT

Apparatus, methods, and computer program products for wireless communication are provided. An example method may include receiving a configuration of a set of RS resources for transmission during an RRC non-connected state and a suspend timer associated with the set of RS resources. The example method may further include entering an RS valid state based on the reception of the configuration. The example method may further include performing a first set of measurements based on a set of RSs. The example method may further include entering an RS suspend state based on the set of RSs being inaccurately measured. The example method may further include performing a second set of measurements based on the set of RSs. The example method may further include entering the RS valid state based on the second set of measurements being accurately measured before an expiration of the suspend timer.

### CROSS REFERENCE TO RELATED APPLICATIONS

This application claims the benefit of and priority to Indian Provisional Patent Application No. 202341040899, entitled “MECHANISM TO SUSPEND/RESUME RS RESOURCES IN RRC-INACTIVE” and filed on Jun. 15, 2023, which is expressly incorporated by reference herein in its entirety.

### TECHNICAL FIELD

The present disclosure relates generally to communication systems, and more particularly, to wireless communication systems with reference signal (RS) resources.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on stored information that is stored in the at least one memory, the at least one processor is configured to cause the apparatus to receive, from a network node, a configuration of a set of reference signal (RS) (e.g., sidelink or uplink RSs for positioning) resources for transmission during a radio resource control (RRC) non-connected state and a suspend timer associated with the set of RS resources. Based at least in part on stored information that is stored in the at least one memory, the at least one processor is configured to cause the apparatus to enter an RS valid state based on the reception of the configuration. Based at least in part on stored information that is stored in the at least one memory, the at least one processor is configured to cause the apparatus to perform a first set of measurements based on a set of RSs associated with the configuration. Based at least in part on stored information that is stored in the at least one memory, the at least one processor is configured to cause the apparatus to enter an RS suspend state based on the set of RSs being inaccurately measured. Based at least in part on stored information that is stored in the at least one memory, the at least one processor is configured to cause the apparatus to perform a second set of measurements based on the set of RSs. Based at least in part on stored information that is stored in the at least one memory, the at least one processor is configured to cause the apparatus to enter the RS valid state based on the second set of measurements being accurately measured before an expiration of the suspend timer.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram that illustrates low-power high-accuracy positioning (LPHAP) without sounding reference signal (SRS) pre-configuration.

FIG. 6 is a diagram that illustrates LPHAP with SRS pre-configuration.

FIG. 7 is a diagram that illustrates that a subset of the SRS configuration parameters could be common across multiple cell and therefore it is feasible to at least partially pre-configure an SRS across multiple cells.

FIG. 8 is a diagram that illustrates example parameters that may be configured before activation message or provided in activation message.

FIG. 9 is a diagram that illustrates example SRS.

FIG. 10 is a diagram that illustrates an example state transition diagram for SRS, or other sidelink or uplink RSs used for positioning.

FIG. 11 is a diagram illustrating an example observation period and M=4 for M-consecutive observations for valid state.

FIG. 12 is a diagram illustrating an example observation period and M=4 for M-consecutive observations for suspend state.

FIG. 13 is a flowchart of a method of wireless communication.

FIG. 14 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects provided herein may provide a state transition of reference signal with three different states, valid state, suspend state, and invalid state. By having three different states, a user equipment (UE) may be able to more efficiently manage configured reference signal resources and signaling overhead between the network node and the UE may be reduced due to the UE reducing the number of transmissions of requesting new reference signal configurations.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

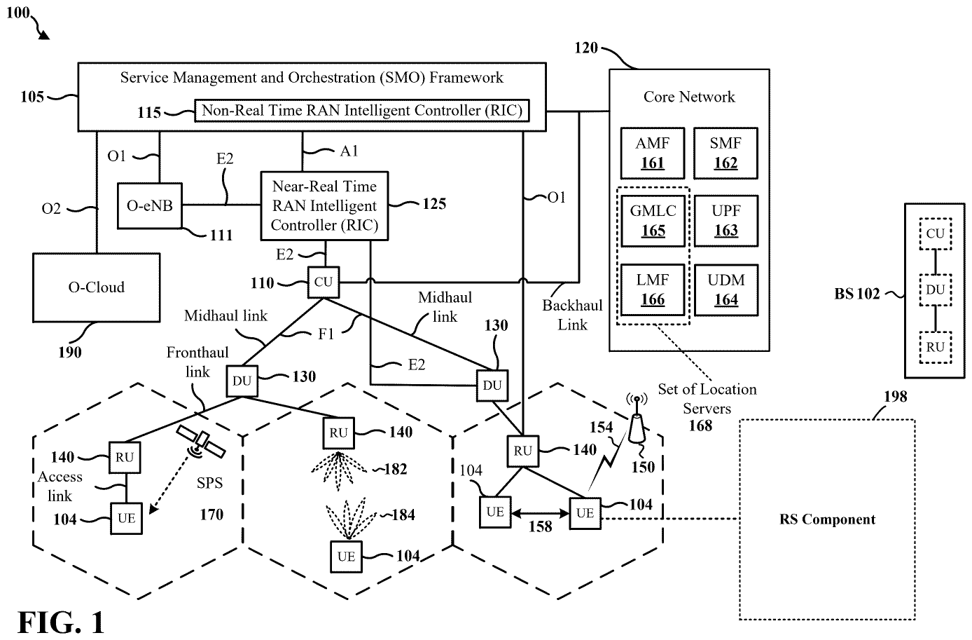

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/IL models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to YMHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an RS component 198. In some aspects, the RS component 198 may be configured to receive, from a network node, a configuration of a set of reference signal (RS) resources for transmission during a radio resource control (RRC) non-connected state and a suspend timer associated with the set of RS resources. In some aspects, the RS component 198 may be further configured to enter an RS valid state based on the reception of the configuration. In some aspects, the RS component 198 may be further configured to perform a first set of measurements based on a set of RSs associated with the configuration. In some aspects, the RS component 198 may be further configured to enter an RS suspend state based on the set of RSs being inaccurately measured. In some aspects, the RS component 198 may be further configured to perform a second set of measurements based on the set of RSs. In some aspects, the RS component 198 may be further configured to enter the RS valid state based on the second set of measurements being accurately measured before an expiration of the suspend timer.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

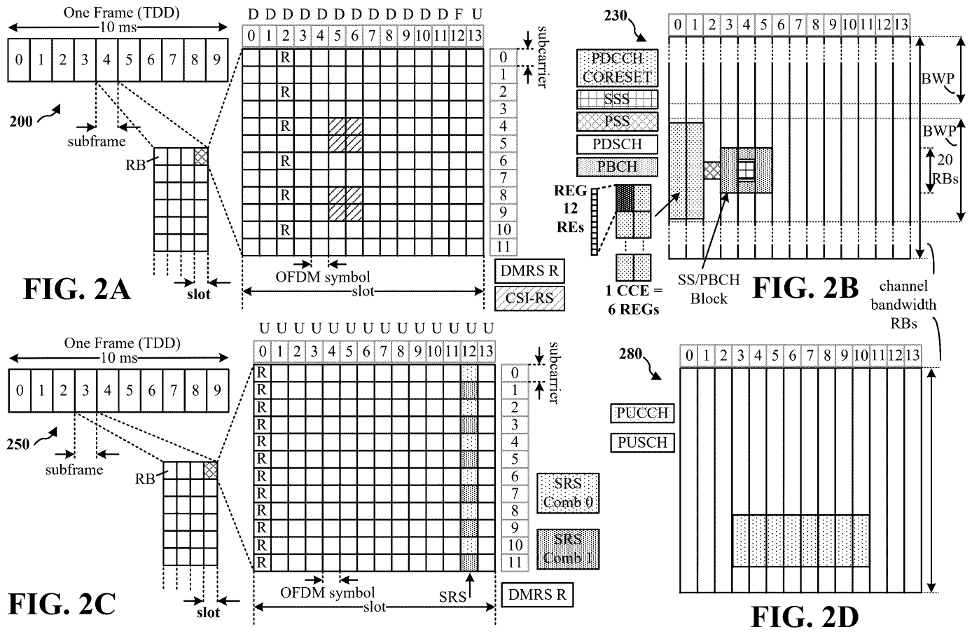

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 29 slots/subframe. The subcarrier spacing may be equal to 2^{μ*}15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

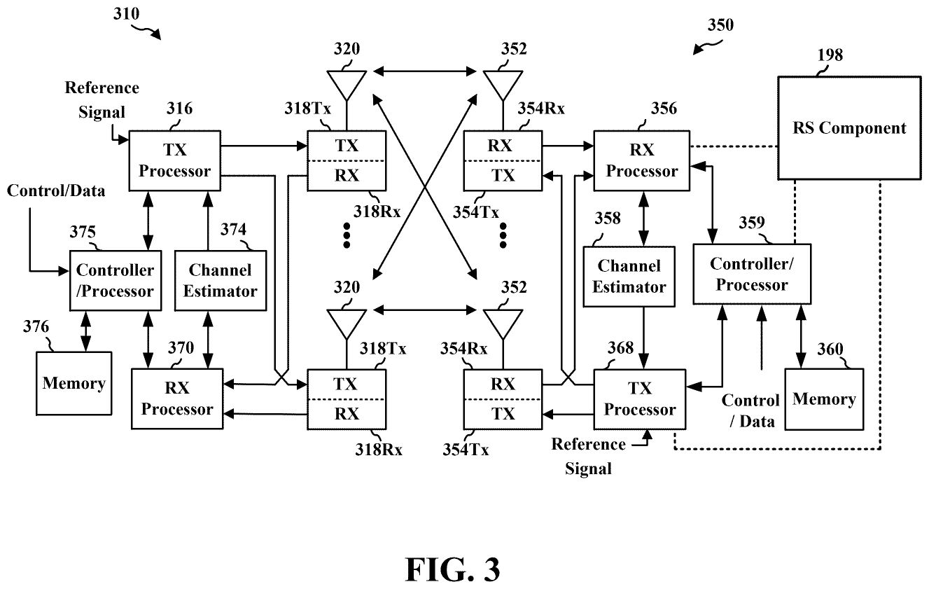

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with RS component 198 of FIG. 1.

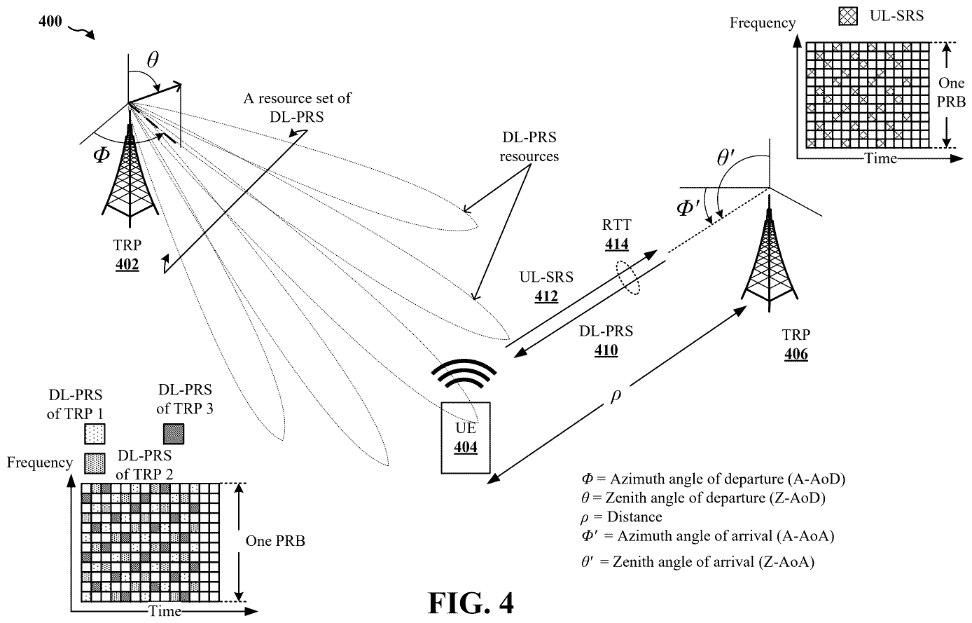

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

As used herein, the term “RRC non-connected state” may refer to an idle state or inactive state. As used herein, the term “suspend timer” may refer to a timer for moving from an “RS suspend state” entered based on measurements associated with an RS being below a threshold to an “RS invalid state” where the RS may be considered to be invalid. As used herein, the term “RS valid state” may refer to a state where the RS may be considered to be valid. In some aspects, the term “observation period” may refer to a period where the UE may perform measurements before the transition from one state to another based on measurements to verify whether to transition the state. For example, there may be an observation period associated with transitioning from a valid state to a suspend state. There may be an observation period associated with transitioning from a suspend state to a valid state. In some aspects, there may be no observation period when the transition is based on expiry of a validity timer, such as a transition from a valid state to an invalid state based on expiry of the validity timer. A UE may take a particular quantity of consecutive measurement(s) during the observation period. In some aspects, the term “measurement” may refer to a reference signal received power (RSRP) measurement, a signal to interference and noise ratio (SINR) measurement, a receives signal strength indicator (RSSI) measurement, or the like. As used herein, the term “pre-configured” may refer to being configured before activation, which may be configured via dedicated RRC signaling. As used herein, the term “inaccurately measured” may refer to a scenario where a measurement falls below a configured threshold.

SRS for positioning configurations in multiple cells may be used. An example configured SRS configuration may be provided below:

```
SRS-PosRRC-Inactive-R18 ::= SEQUENCE (SIZE (1...maxPreConfig)) OF SRS-
PosRRC-InactivePreConfig-r18
SRS-PosRRC-InactivePreConfig-r18 ::= SEQUENCE {
  srs-PosID-r18 Integer (1...maxIDs),
  srs-ValidityArea-r18 Area-ID-CellList-r18 Optional,
  srs-PosConfigNUL-r18 SRS-PosPreConfig-r18 OPTIONAL,
  srs-PosConfigSUL-r18 SRS-PosPreConfig-r18 OPTIONAL,
  bwp-NUL-r18 BWP OPTIONAL,
  bwp-SUL-r18 BWP OPTIONAL,
  inactivePosSRS-TimeAlignmentTimer-r18 TimeAlignmentTimer OPTIONAL
  inactivePosSRS-RSRP-changeThreshold-r18 RSRP-ChangeThreshold-r17
OPTIONAL
}
```

The parameter srs-PosID-r18 may represent a set of up to maxPreConfig positioning SRS configurations, where each configuration can be identified by an srs-PosID in the set of srs-PosID-r18.

The parameter srs-ValidityArea provides a list of Cell-IDs where this SRS configuration is valid.

The parameter srs-PosConfigNUL may represent configuration of SRS for positioning configuration in RRC_INACTIVE state in normal uplink carrier. The parameter srs-PosConfigSUL-r18 may represent configuration of SRS for positioning configuration in RRC_INACTIVE state in supplementary uplink carrier.

The parameter bwp-NUL may represent BWP configuration for SRS for positioning during the RRC_INACTIVE state in normal uplink carrier. If the field is absent UE is configured with an SRS for Positioning associated with the initial UL BWP and transmitted, during the RRC_INACTIVE state, inside the initial UL BWP with the same cyclic prefix (CP) and SCS as configured for initial UL BWP.

The parameter bwp-SUL may represent BWP configuration for SRS for positioning during the RRC_INACTIVE state in supplementary uplink carrier. If the field is absent UE is configured with an SRS for positioning associated with the initial UL BWP and transmitted, during the RRC_INACTIVE state, inside the initial UL BWP with the same CP and SCS as configured for initial UL BWP.

The parameter inactivePosSRS-RSRP-ChangeThreshold may represent reference signal received power (RSRP) threshold for the increase/decrease of RSRP for time alignment validation.

The parameter inactivePosSRS-TimeAlignmentTimer may be a timer that controls how long the medium access control (MAC) entity considers the positioning SRS transmission in RRC_INACTIVE to be uplink time aligned.

To enable more network control over the positioning SRS transmission after cell reselection, the LTE positioning protocol (LPP) Area-ID-CellList may also be introduced for the (pre-) configured positioning SRS. Compared to the DL-PRS assistance data validity, the Area-ID-CellList for positioning SRS would be UE specific. If the UE camps on a cell whose ID is included in the Area-ID-CellList the UE would be permitted to continue the (associated) positioning SRS transmission in the new cell after cell reselection. The SRS-PosRRC-Inactive provides a set of up to maxPreConfig positioning SRS configurations, where each configuration can be identified by an srs-PosID. The srs-ValidityArea provides a list of Cell-IDs where this SRS configuration is valid. If the UE reselects to a cell included in the Area-ID-CellList, the UE is permitted to continue SRS transmission during/after cell reselection. The Area-ID-CellList may not necessarily coincide with an RNA and could be a dedicated, UE-specific, UL positioning area. This avoids SRS interruption at cell reselection, which reduces the amount of SRS configuration signalling used, reduces the latency, and hence power consumption at the target device.

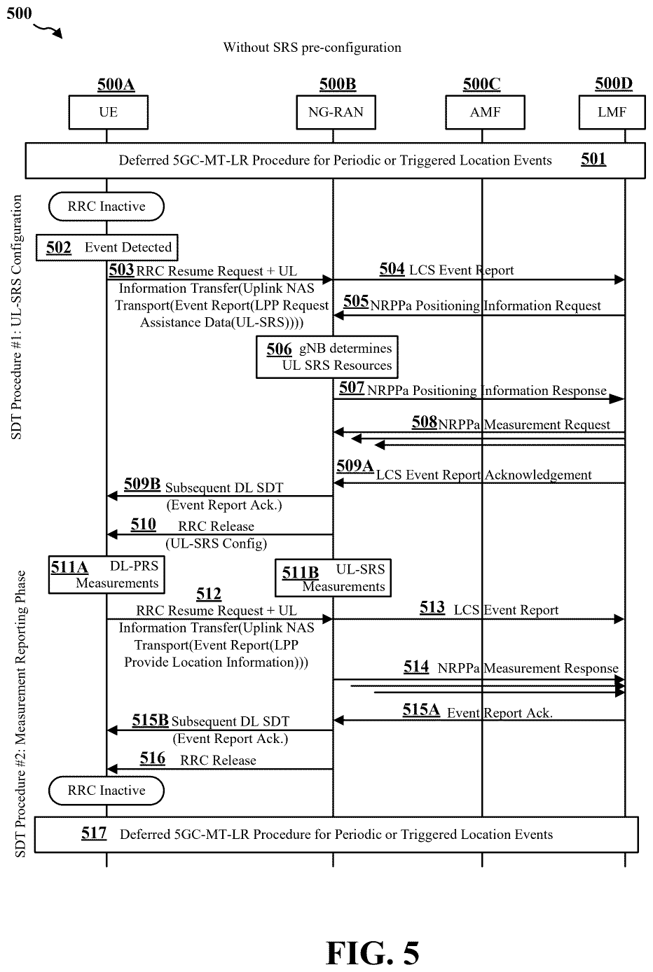

FIG. 5 is a diagram 500 that illustrates low-power high-accuracy positioning (LPHAP) without sounding reference signal (SRS) pre-configuration. A UE 500A, an RAN 500B, an AMF 500C, and a LMF 500D may be involved. At 501, Deferred 5GC-Mobile Terminal-Location Request (MT-LR) procedure for periodic or triggered location events may be configured. The UE 500A may be in an RRC inactive state. At 502, an event may be detected by the UE 500A and the UE 500A may transmit an RRC resume request with UL information transfer 503, which may include UL non-access stratum (NAS) transport which includes event report, LPP request assistance data, and UL SRS to a RAN 500B. The RAN 500B may accordingly transmit location services (LCS) event report 504 to the LMF 500D. The LMF 500D may accordingly transmit an NR Positioning Protocol A (NRPPa) positioning information request 505 to the RAN 500B. At 506, a network node of the RAN 500B may determine UL SRS resources. The RAN 500B may transmit an NRPPa positioning information response 507 to the LMF 500D and receive NRPPa measurement request 508 from the LMF 500D (e.g., multiple network nodes of the RAN 500B may receive the NRPPa measurement request 508). The RAN 500B may also receive the LCS event report acknowledgment 509A and accordingly transmit subsequent DL small data transfer (SDT) 509B to the UE 500A to forward the LCS event report acknowledgment. The RAN 500B may also transmit RRC release 510 for the UE 500A. The RRC release 510 may include UL SRS configuration(s). The UE may perform DL PRS measurements at 511A and the RAN 500B may perform UL SRS measurements at 5111B. The UE 500A may transmit an RRC resume request with UL information transfer 512 to the RAN 500B. The RRC resume request with UL information transfer 512 may include UL NAS transport which may include event report. The RAN 500B may transmit an LCS event report 513 to the LMF 500D and different network nodes of the RAN 500B may transmit respective NRPPa measurement response 514 to the LMF 500D. The RAN 500B may then receive event report acknowledgment 515A from the LMF 500D, and accordingly transmit subsequent DL SDT 515B to the UE 500A. The UE 500A may enter an RRC inactive state after receiving an RRC release 516. At 517, deferred 5GC-MT-LR procedure for periodic or triggered location events may occur again.

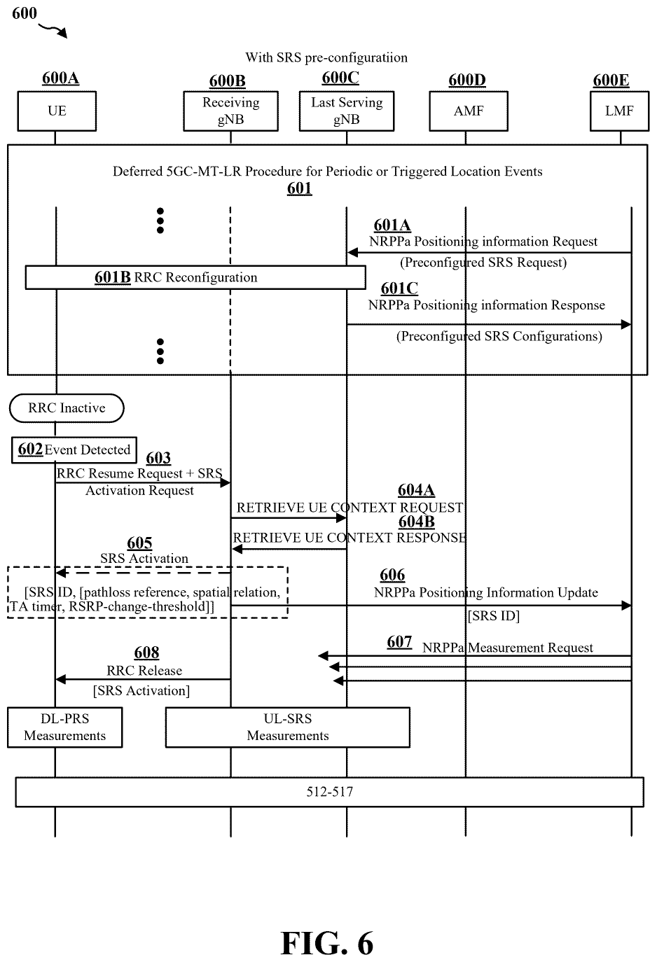

FIG. 6 is a diagram 600 that illustrates LPHAP with SRS pre-configuration. A UE 600A, a receiving network node 600B, a last serving network node 600C, an AMF 600D, and a LMF 600E may be involved. At 601, deferred 5GC-MT-LR procedure for periodic or triggered location events may occur. As part of 601, the LMF 600E may transmit NRPPa positioning information request 601A, which may include preconfigured SRS request, to the last serving network node 600C. The UE 600A, the receiving network node 600B, or the last serving network node 600C, may perform RRC reconfiguration for the UE 600A at 601B. The last serving network node 600C may transmit NRPPa positioning information response 601C, which may include preconfigured SRS configurations, to the LMF 600E. The UE 600A may enter an RRC inactive state later at some point. Upon detection of an event at 602, the UE may transmit an RRC resume request with an SRS activation request 603 to the receiving network node 600B. The receiving network node 600B may accordingly transmit retrieve UE context request 604A and receive retrieve UE context response 604B to obtain information related to the UE 600A. After receiving the retrieve UE context response 604B, the receiving network node 600B may transmit an SRS activation 605, which may include SRS ID and associated pathloss reference, spatial relation, timing advance (TA) timer, or RSRP change threshold to the UE 600A. The receiving network node 600B may also transmit NRPPa positioning information update 606 with the SRS ID to the LMF 600E. The LMF 600E may transmit NRPPa measurement request 607 to various network nodes of the RAN, such as the receiving network node 600B or the last serving network node 600C. The receiving network node 600B may transmit an RRC release 608, which may include SRS activation, for the UE 600A. The UE 600A may perform DL-PRS measurements and the receiving network node 600B may perform UL-SRS measurements.

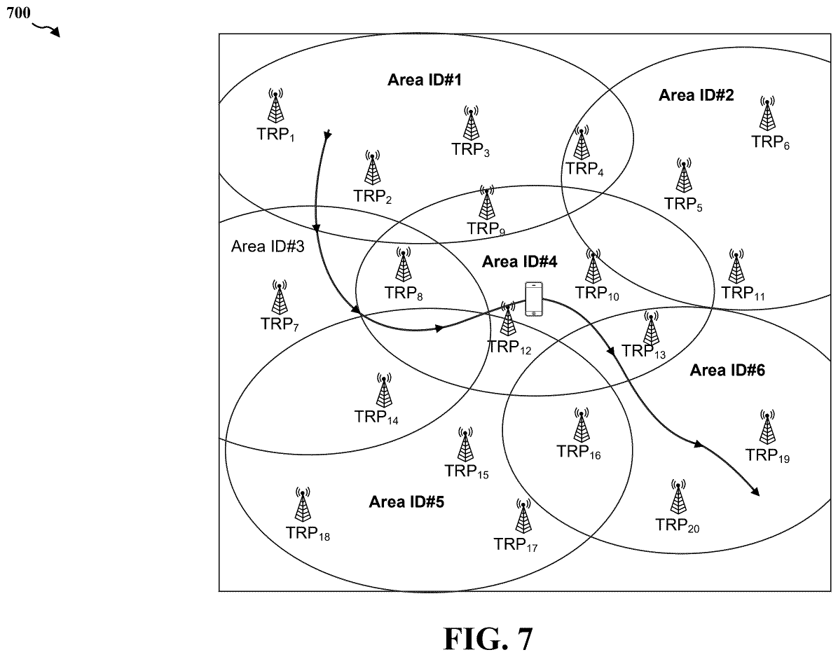

FIG. 7 is a diagram 700 that illustrates that a subset of the SRS configuration parameters could be common across multiple cell and therefore it is feasible to at least partially pre-configure an SRS across multiple cells. As illustrated in FIG. 7, TRP1, TRP2, TRP3, TRP4, and TRP9 may be included in AreaID #1. TRP4, TRP5, TRP6, and TRP11 may be included in AreaID #2. TRP7, TRP8, and TRP14 may be included in AreaID #3. TRP8, TRP9, TRP10, TRP12, and TRP13 may be included in AreaID #4. TRP12, TRP14, TRP15, TRP16, TRP17, and TRP18 may be included in AreaID #5. TRP13, TRP16, TRP19, and TRP20 may be included in AreaID #6. For TRPs within a particular area, in some aspects, some parameters in an associated SRS configuration for the TRP may be common, including: comb-type, number of symbols, symbol offset, bandwidth and SRS frequency, periodicity and slot offset, sequence hopping parameters, and number of resources in a set. For TRPs within a particular area, in some aspects, some parameters in an associated SRS configuration for the TRP may be not common, such as power control parameters, spatial relation information, and SSB information.

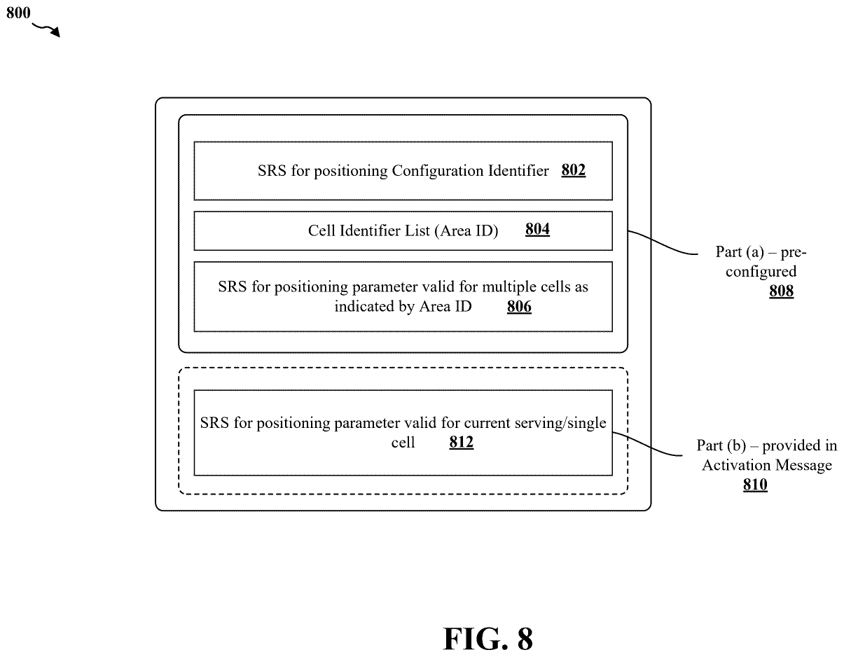

FIG. 8 is a diagram 800 that illustrates example parameters that may be configured before activation message or provided in activation message. As illustrated in FIG. 8, SRS for positioning configuration identifier 802, cell identifier list (Area ID) 804, and SRS for positioning parameter valid for multiple cells as indicated by Area ID 806 may be pre-configured 808 (e.g., configured before activation). In some aspects, SRS for positioning parameter valid for current serving/single cell 812 may be provided in activation message 810.

Conditional SRS transmission in the SRS pre-configuration RRC-inactive feature may be present. The UE is preconfigured by the network with multiple SRS resources, associated with a PCI, when it is camped on a given PCI in an area. The UE may transmit a subset of those SRS resources and not all of those SRS resources, based on a set of criteria. A first condition may be conditional transmission of SRS resource based on the RSRP measurement on the SSB/CSI-RS configured for path-loss measurement with the SRS resources. A second condition may be conditional transmission of SRS resource based on the RSRP measurement on the SSB/CSI-RS configured for spatial relation measurement with the SRS resources. As an example, in FR2, a device is configured with multiple SRS resources for each potential cell the device might camp on in an area. The device determines which of the SSBs is being well received, and it uses a Tx beam derived based on that determination.

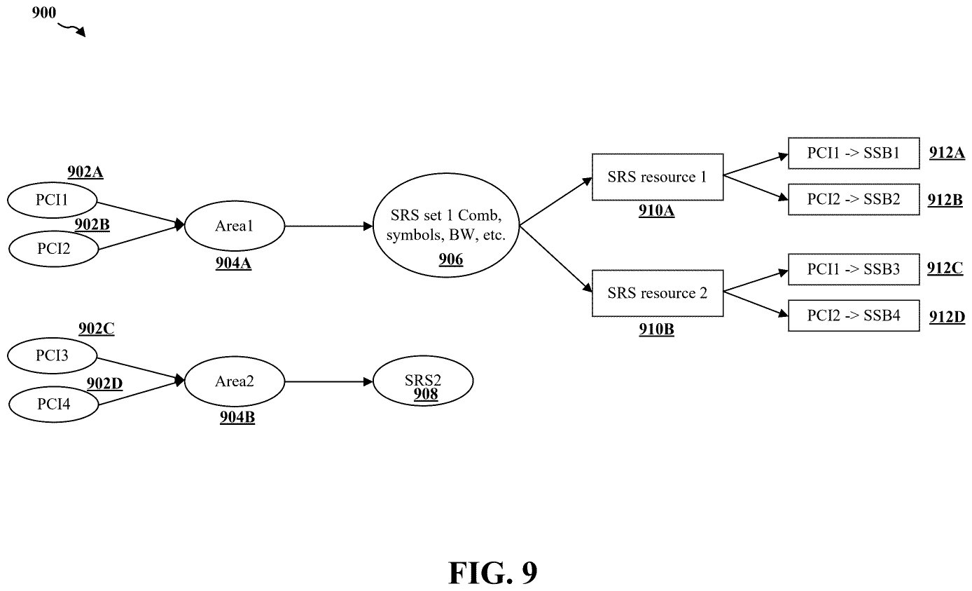

FIG. 9 is a diagram 900 that illustrates example SRS. As illustrated in FIG. 9, four different PCIs including PCI1 902A, PCI2 902B, PCI3 902C, and PCI4 902D may be provided. The PCI1 902A and the PCI2 902B may be long to a first area, Area1 904A. The PCI3 902C and the PCI4 902D may be long to a second area, Area2 904B. The first area Area1 904A may be associated with a first SRS set 906 associated with a comb type, a number of symbols, a symbol offset, a bandwidth and an SRS frequency, a periodicity and a slot offset, sequence hopping parameters, and number of resources in a set. The second area Area2 904B may be associated with a second SRS set 908 associated with different parameters that may have different values for a comb type, a number of symbols, a symbol offset, a bandwidth and an SRS frequency, a periodicity and a slot offset, sequence hopping parameters, and number of resources in a set. For example, the second SRS set 908 may include a single SRS resource instead of multiple SRS resources. The first SRS set 906 may include a first SRS resource 910A and a second SRS resource 910B. In some aspects, the first SRS resource 910A may include a first SSB, SSB1 912A for the PCI1 902A and a second SSB, SSB2 912B for the PCI2 902B. In some aspects, the second SRS resource 910B may include a third SSB, SSB3 912C for the PCI1 902A and a fourth SSB, SSB4 912D for the PCI2 902B.

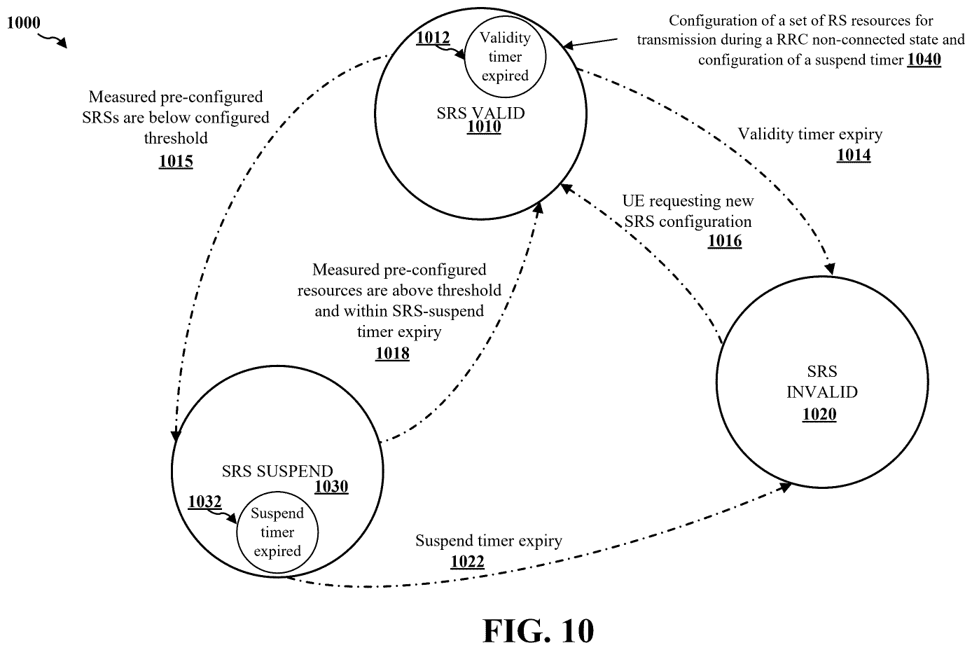

Aspects provided herein may provide a state transition of reference signal with three different states, valid state, suspend state, and invalid state. By having three different states, a UE may be able to more efficiently manage configured reference signal resources and signaling overhead between the network node and the UE may be reduced due to the UE reducing the number of transmissions of requesting new reference signal configurations. FIG. 10 is a diagram 1000 that illustrates an example state transition diagram for SRS, or other sidelink or uplink RSs used for positioning. Although example descriptions are provided for SRS, the described aspects are applicable to other sidelink or uplink RSs used for positioning may be used as well.

As illustrated in FIG. 10, the UE may receive a configuration of a set of RS resources for transmission during an RRC non-connected state and a suspend timer associated with the set of RS resources 1040 and the UE may accordingly enter the SRS valid state 1010. In some aspects, in the SRS valid state 1010 and a validity timer may expire at 1012. Upon validity timer expiry 1014, the UE may enter an SRS invalid state 1020. After entering the SRS invalid state 1020, the UE may request a new SRS configuration at 1020. Upon receiving the new SRS configuration, the UE may re-enter the SRS valid state 1010.

In the SRS valid state 1010, if measured pre-configured SRSs are below a configured threshold (e.g., RSRP, RSSI, SINR or other measurements associated with the pre-configured SRSs are below a configured threshold), the UE may enter an SRS suspend state 1030. In the SRS suspend state 1030, if suspend timer expired at 1032, then upon the suspend timer expiry 1022, the UE may enter the SRS invalid state. In the SRS suspend state 1030, the UE may perform measurements on the pre-configures SRSs. If the measured pre-configured SRSs are above a configured threshold at 1018 (e.g., RSRP, RSSI, SINR or other measurements associated with the pre-configured SRSs are above a configured threshold), the UE may re-enter the SRS valid state 1010. In some aspects, the configured threshold for re-entering the SRS valid state 1010 from the SRS suspend state 1030 may be the same as the configured threshold for entering the SRS suspend state 1030 from the SRS valid state 1010. In some aspects, the configured threshold for re-entering the SRS valid state 1010 from the SRS suspend state 1030 may be different from the configured threshold for entering the SRS suspend state 1030 from the SRS valid state 1010. In some aspects, the configured threshold for re-entering the SRS valid state 1010 from the SRS suspend state 1030 may be separately configured from the configured threshold for entering the SRS suspend state 1030 from the SRS valid state 1010. In some aspects, measurements associated with re-entering the SRS valid state 1010 from the SRS suspend state 1030 may include measurement on additional resources compared to the measurements associated with entering the SRS suspend state 1030 from the SRS valid state 1010.

For the valid state, the network may have configured the RS (e.g., SRS) resources to the UE with UL timing associations. The UE may measure and periodically transmit based on the SRS resources to the network. Validity timer may be configured by the network and the UE may start the validity timer as soon as its move to SRS valid state 1010. After validity timer expiry, the UE may move to SRS invalid state 1020.

For suspend state, the network may have configured the suspend timer. The UE may start the suspend timer as soon as its move to the SRS suspend state 1030. The UE may move to SRS suspend state 1030, if measured pre-configured PRS resources are below pre-configured thresholds. On suspend timer expiry, UE may move to SRS invalid state 1020. The UE may keep on doing the SRS resource measurements in the SRS suspend state 1030. The UE may move to SRS valid state 1010 if UE is able to measure the SRS resources with configured thresholds. To move out of the SRS invalid state 1020, the UE may get a new SRS configuration from the network.

In the valid state, in some aspects, there may be an observation period. Network may configure the observation period for the SRS VALID state. The UE may measure RSs such as SSB and transmit SRS resources periodically in VALID state. The UE may leave the valid state if the UE is not able to measure the set of SSB resource configured above thresholds continuously for T observation time.

In the valid state, in some aspects, there may be a configuration of M-consecutive observations. The network may configure the minimum number of M continuous measurements for the VALID state. The UE may measure RS (such as SRS/SSB) resources periodically in the VALID state. The UE may leave the VALID state if the UE is not able to measure the set of SRS resource configured above thresholds continuously for M measurements. The UE may restart the M count if UE miss the threshold for any measurement occasion. In one embodiment, a UE in an SRS-Valid state may measure and periodically transmit the SRS resources to a base station during a validity time window. An SRS-Suspend state may be triggered if measured pre-configured PRS resources are below a pre-configured threshold. If the UE is able to measure the SRS resources within a configured threshold, it may return to the SRS-Valid state. Otherwise, the UE may enter the SRS-Invalid state, and may be reset by receiving a new SRS configuration from the network.

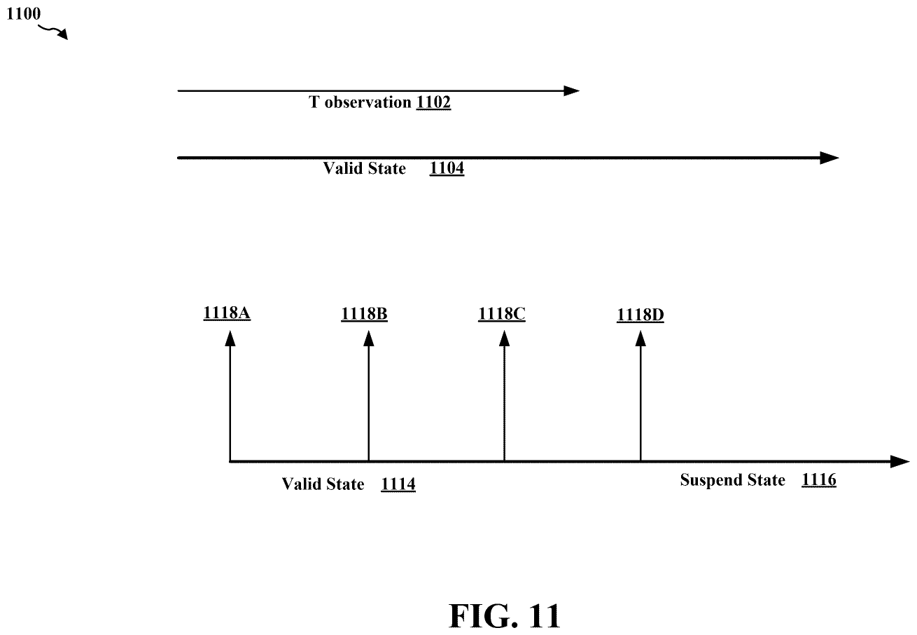

FIG. 11 is a diagram 1100 illustrating an example observation period and M=4 for M-consecutive observations for valid state.

In the valid state 1104, in some aspects, there may be an observation period 1102. For example, the network may configure the observation period for the SRS valid state 1010. The UE may measure SRS resources periodically in the valid state including a first measurement 1118A, a second measurement 1118B, a third measurement 1118C, and a fourth measurement 1118D. The UE may leave the valid state 1114 and enter the suspend state 1116 if the UE is able to measure the set of SRS resource configured to be below the configured threshold continuously for the T observation time (which corresponds to the observation period 1102). The UE may restart the T observation timer if a particular measurement meets the threshold during the T observation time.

In the suspend state, in some aspects, there may be an observation period. The network may configure the observation period for the SRS suspend state. The UE measure SRS resources periodically in the suspend state. The UE may leave the SUSPEND state and enter the VALID state if the UE is able to measure the set of SRS resource configured above thresholds continuously for the T observation time. The UE may restart the T observation timer if UE miss the threshold during the T observation time.

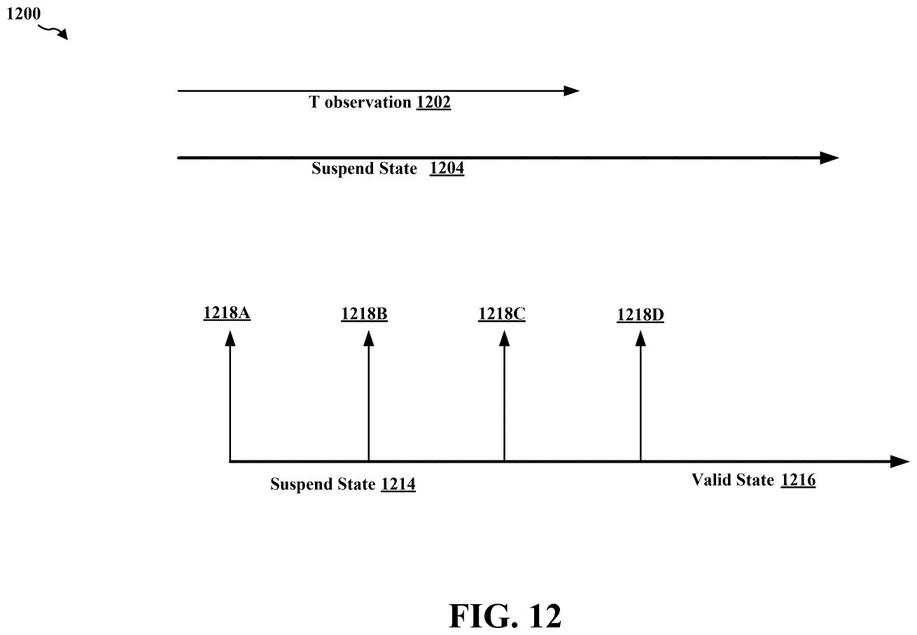

In the suspend state, in some aspects, there may be a configuration of M-consecutive observations. The network may configure the minimum number of M continuous measurements for the SUSPEND state. The UE may measure SRS resources periodically in the suspend state. The UE may leave the SRS suspend state 1030 if the UE is able to measure the set of SRS resource configured above thresholds continuously for M measurement period. The UE may restart the M count if UE miss the threshold for any measurement occasion. FIG. 12 is a diagram 1200 illustrating an example observation period and M=4 for M-consecutive observations for suspend state.

In the suspend state 1204, in some aspects, there may be an observation period 1202. For example, the network may configure the observation period for the SRS suspend state 1030. The UE may measure SRS resources periodically in the valid state including a first measurement 1218A, a second measurement 1218B, a third measurement 1218C, and a fourth measurement 1218D. The UE may leave the suspend state 1214 and enter the valid state 1216 if the ULE is able to measure the set of SRS resource configured to be above threshold continuously for the T observation time (which corresponds to the observation period 1202). The UE may restart the T observation timer if a particular measurement fails to meet the threshold during the T observation time.

The network may configure the periodicity of measurements in the suspend state, which may be same as valid state measurements periodicity or different periodicity for valid state and suspend state independently. The network may configure the resource set measurements for SRS configuration selection. For example, the ULE may measure SSB1 and SSB2 in SRS valid state 1010 and may measure SSB1 SSB2, SSB3, SSB 4 in SRS invalid state 1020. The LMF/gNB or the network may allow more resource measurements in SRS suspend state 1030 and may configure periodicity of SRS-SUSPEND and SRS-VALID such that the power consumption is same (e.g., similar) in both the states, such as by configuring more resource set for measurements, higher periodicity for measurements for getting the same power consumption. Reselection to a new cell may be consider as opportunity to move to SRS valid state 1010. During reselection, there may be more SSB measurements from serving cell and neighbor cell measurements. The SSB measurements can help the ULE to select the right SRS configuration after the reselection.

There may be cell specific SRS-SUSPEND configuration in the RRC INACTIVE state. For example, there may be cell specific T observation period, M-sample, suspend timer, or the like. There may be configured SRS resource set for moving a UE to suspend state. The UE may be configured with subset of RS (e.g., SSB/SRS) resource to take decision for suspend state. For example, 10 SRS resource may be configured, 4 of the 10 may be configured for SUSPEND monitoring. The UE may UE may move to SRS suspend state 1030, if all of the 4 SRS resource are measured below threshold.

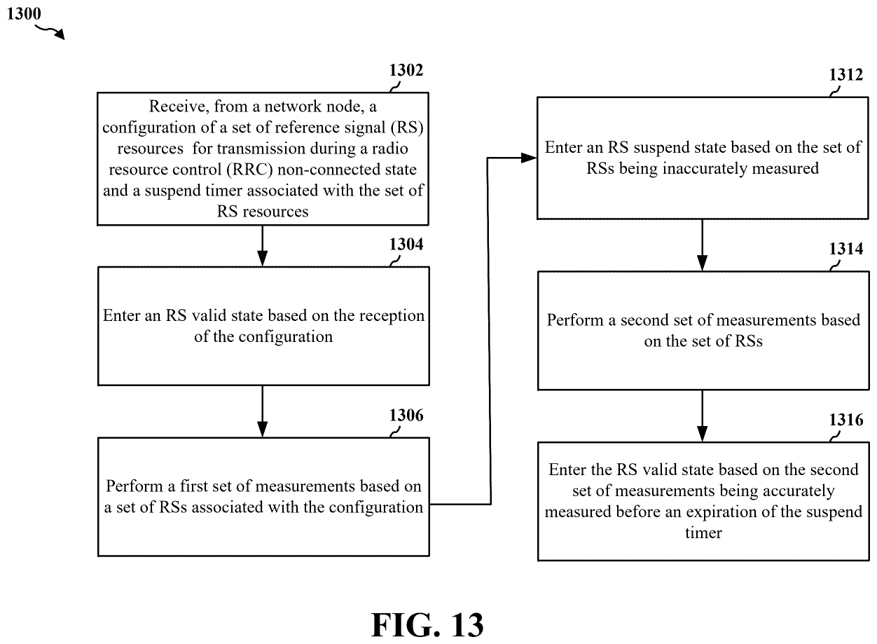

FIG. 13 is a flowchart 1300 of a method of wireless communication. The method may be performed by a UE (e.g., the UE 104).

At 1302, the UE may receive, from a network node, a configuration of a set of RS resources for transmission during an RRC non-connected state and a suspend timer associated with the set of RS resources. For example, the UE may receive a configuration of a set of RS resources for transmission during an RRC non-connected state and a suspend timer associated with the set of RS resources (e.g., 1040). In some aspects, 1302 may be performed by the RS component 198.

At 1304, the UE may enter an RS valid state based on the reception of the configuration. For example, the UE may enter an RS valid state (e.g., 1010) based on the reception of the configuration (e.g., 1040). In some aspects, 1304 may be performed by the RS component 198.

At 1306, the UE may perform a first set of measurements based on a set of RSs associated with the configuration. In some aspects, 1306 may be performed by the RS component 198. For example, the UE may perform a first set of measurements (e.g., at 1015) based on a set of RSs associated with the configuration.

At 1312, the UE may enter an RS suspend state based on the set of RSs being inaccurately measured. For example, the UE may enter an RS suspend state (e.g., 1030) based on the set of RSs being inaccurately measured (e.g., at 1015). In some aspects, 1312 may be performed by the RS component 198.

At 1314, the UE may perform a second set of measurements based on the set of RSs. For example, the UE may perform a second set of measurements (e.g., at 1018) based on the set of RSs. In some aspects, 1314 may be performed by the RS component 198.

At 1316, the UE may enter the RS valid state based on the second set of measurements being accurately measured before an expiration of the suspend timer. For example, the UE may enter the RS valid state (e.g., 1010) based on the second set of measurements being accurately measured (e.g., at 1018) before an expiration of the suspend timer. In some aspects, 1316 may be performed by the RS component 198.

In some aspects, the UE may receive, from the network node, a configuration of an observation period (e.g., 1102) for the RS valid state (e.g., 1104). In some aspects, the UE may perform the first set of measurements (e.g., 1118A to 1118D) during the observation period. In some aspects, to enter the RS suspend state (e.g., 1116) based on the set of RSs being inaccurately measured, the UE may enter the RS suspend state (e.g., 1116) based on the set of RSs being inaccurately measured during an entirety of the observation period (e.g., 1102). In some aspects, the UE may receive, from the network node, a configuration of a quantity of consecutive measurements for the RS valid state (e.g., 1114). In some aspects, the UE may perform the first set of measurements for the quantity of consecutive measurements. In some aspects, to enter the RS suspend state based on the set of RSs being inaccurately measured, the UE may enter the RS suspend state based on the set of RSs being inaccurately measured for all of the quantity of consecutive measurements (e.g., 1118A to 1118D). In some aspects, the UE may re-perform the first set of measurements for the quantity of consecutive measurements based on at least one measurement of the quantity of consecutive measurements being inaccurately measured.

In some aspects, the UE may receive, from the network node, a configuration of a validity timer (e.g., 1012) associated with the RS valid state (e.g., 1010). In some aspects, the UE may enter an RS invalid state (e.g., 1020) based on an expiration of the validity timer (e.g., at 1014). In some aspects, the UE may transmit, to the network node, a request for an updated configuration of RSs (e.g., at 1016).

In some aspects, the UE may receive, from the network node, a configuration of an observation period (e.g., 1202) for the RS suspend state (e.g., 1204). In some aspects, the UE may perform the second set of measurements (e.g., 1218A to 1218D) during the observation period. In some aspects, to enter the RS valid state (e.g., 1216) based on the second set of measurements being accurately measured, the UE may enter the RS valid state based on the second set of measurements being accurately measured during an entirety of the observation period (e.g., 1202). In some aspects, the UE may receive, from the network node, a configuration of a quantity of consecutive measurements for the RS suspend state. In some aspects, the UE may perform the second set of measurements for the quantity of consecutive measurements. In some aspects, to enter the RS valid state based on the second set of measurements being accurately measured, the UE may enter the RS valid state (e.g., 1216) based on the second set of measurements being accurately measured for all of the quantity of consecutive measurements (e.g., 1218A to 1218D). In some aspects, to perform the second set of measurements based on the set of RSs, the UE may perform the second set of measurements based on the set of RSs and a second set of RSs (which may be separately configured).

In some aspects, the first set of measurements is associated with a first periodicity (e.g., a periodicity for 1118A to 1118D) and the second set of measurements is associated with a second periodicity (e.g., a periodicity for 1218A to 1218D), the UE may receive, from the network node, information indicative of the first periodicity and the second periodicity (e.g., in 1040). In some aspects, the UE may enter the valid state based on a reselection of a serving cell or movement to a new area. In some aspects, a first power consumption associated with the first set of measurements and a second power consumption associated with the second set of measurements are different by less than a power consumption threshold. In some aspects, the configuration of the suspend timer and a configuration associated with an observation period for the RS suspend state or a quantity of consecutive measurements for the RS suspend state is associated with a particular cell, a particular group of cells, or an area associated with the network node.

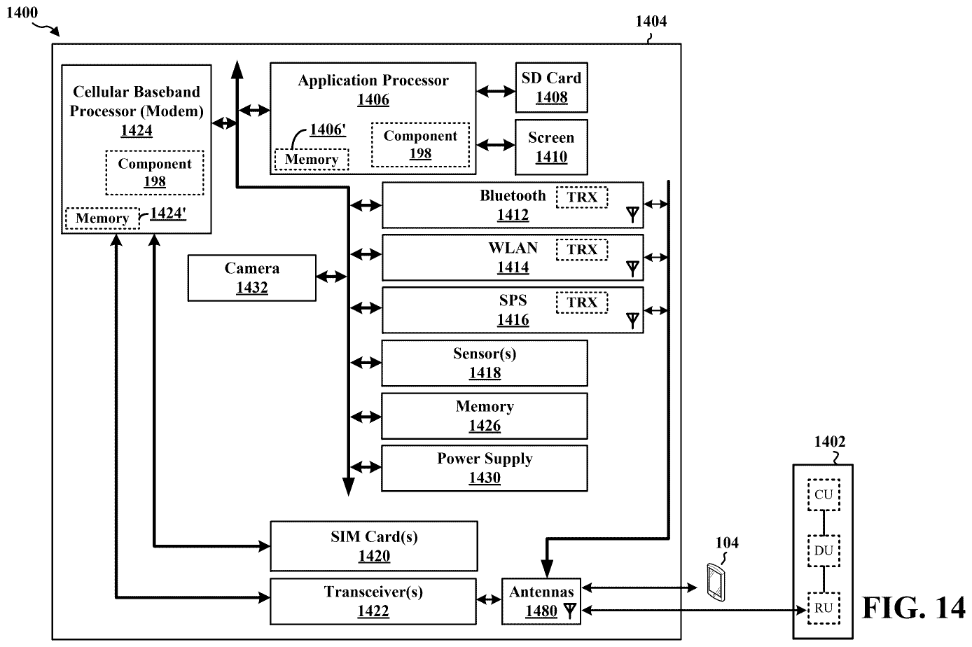

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the RS component 198 may be configured to receive, from a network node, a configuration of a set of RS resources for transmission during an RRC non-connected state and a suspend timer associated with the set of RS resources. In some aspects, the RS component 198 may be further configured to enter an RS valid state based on the reception of the configuration. In some aspects, the RS component 198 may be further configured to perform a first set of measurements based on a set of RSs associated with the configuration. In some aspects, the RS component 198 may be further configured to enter an RS suspend state based on the set of RSs being inaccurately measured. In some aspects, the RS component 198 may be further configured to perform a second set of measurements based on the set of RSs. In some aspects, the RS component 198 may be further configured to enter the RS valid state based on the second set of measurements being accurately measured before an expiration of the suspend timer. The RS component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for receiving, from a network node, a configuration of a set of RS resources for transmission during an RRC non-connected state and a suspend timer associated with the set of RS resources. In some aspects, the apparatus 1404 may include means for entering an RS valid state based on the reception of the configuration. In some aspects, the apparatus 1404 may include means for performing a first set of measurements based on a set of RSs associated with the configuration. In some aspects, the apparatus 1404 may include means for entering an RS suspend state based on the set of RSs being inaccurately measured. In some aspects, the apparatus 1404 may include means for performing a second set of measurements based on the set of RSs. In some aspects, the apparatus 1404 may include means for entering the RS valid state based on the second set of measurements being accurately measured before an expiration of the suspend timer. In some aspects, the apparatus 1404 may include means for receiving, from the network node, a configuration of an observation period for the RS valid state. In some aspects, the apparatus 1404 may include means for performing the first set of measurements during the observation period. In some aspects, the apparatus 1404 may include means for entering the RS suspend state based on the set of RSs being inaccurately measured during an entirety of the observation period. In some aspects, the apparatus 1404 may include means for receiving, from the network node, a configuration of a quantity of consecutive measurements for the RS valid state. In some aspects, the apparatus 1404 may include means for performing the first set of measurements for the quantity of consecutive measurements. In some aspects, the apparatus 1404 may include means for entering the RS suspend state based on the set of RSs being inaccurately measured for all of the quantity of consecutive measurements. In some aspects, the apparatus 1404 may include means for re-performing the first set of measurements for the quantity of consecutive measurements based on at least one measurement of the quantity of consecutive measurements being inaccurately measured. In some aspects, the apparatus 1404 may include means for receiving, from the network node, a configuration of a validity timer associated with the RS valid state. In some aspects, the apparatus 1404 may include means for entering an RS invalid state based on an expiration of the validity timer. In some aspects, the apparatus 1404 may include means for transmitting, to the network node, a request for an updated configuration of RSs. In some aspects, the apparatus 1404 may include means for receiving, from the network node, a configuration of an observation period for the RS suspend state. In some aspects, the apparatus 1404 may include means for performing the second set of measurements during the observation period. In some aspects, the apparatus 1404 may include means for entering the RS valid state based on the second set of measurements being accurately measured during an entirety of the observation period. In some aspects, the apparatus 1404 may include means for receiving, from the network node, a configuration of a quantity of consecutive measurements for the RS suspend state. In some aspects, the apparatus 1404 may include means for performing the second set of measurements for the quantity of consecutive measurements. In some aspects, the apparatus 1404 may include means for entering the RS valid state based on the second set of measurements being accurately measured for all of the quantity of consecutive measurements. In some aspects, the apparatus 1404 may include means for performing the second set of measurements based on the set of RSs and a second set of RSs. In some aspects, the apparatus 1404 may include means for receiving, from the network node, information indicative of the first periodicity and the second periodicity. In some aspects, the apparatus 1404 may include means for entering the valid state based on a reselection of a serving cell or movement to a new area. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication performed by a UE, including: receiving, from a network node, a configuration of a set of RS resources for transmission during an RRC non-connected state and a suspend timer associated with the set of RS resources; entering an RS valid state based on the reception of the configuration; performing a first set of measurements based on a set of RSs associated with the configuration; entering an RS suspend state based on the set of RSs being inaccurately measured; performing a second set of measurements based on the set of RSs; and entering the RS valid state based on the second set of measurements being accurately measured before an expiration of the suspend timer.

Aspect 2 is the method of aspect 1, further including: receiving, from the network node, a configuration of an observation period for the RS valid state; and performing the first set of measurements during the observation period.

Aspect 3 is the method of aspect 2, where entering the RS suspend state based on the set of RSs being inaccurately measured further includes: entering the RS suspend state based on the set of RSs being inaccurately measured during an entirety of the observation period.

Aspect 4 is the method of any of aspects 1-3, further including: receiving, from the network node, a configuration of a quantity of consecutive measurements for the RS valid state; and performing the first set of measurements for the quantity of consecutive measurements.

Aspect 5 is the method of aspect 4, where entering the RS suspend state based on the set of RSs being inaccurately measured further includes: entering the RS suspend state based on the set of RSs being inaccurately measured for all of the quantity of consecutive measurements.

Aspect 6 is the method of any of aspects 4-5, further including: re-performing the first set of measurements for the quantity of consecutive measurements based on at least one measurement of the quantity of consecutive measurements being inaccurately measured.

Aspect 7 is the method of any of aspects 1-6, further including: receiving, from the network node, a configuration of a validity timer associated with the RS valid state; entering an RS invalid state based on an expiration of the validity timer; and transmitting, to the network node, a request for an updated configuration of RSs.

Aspect 8 is the method of any of aspects 1-7, further including: receiving, from the network node, a configuration of an observation period for the RS suspend state; and performing the second set of measurements during the observation period.

Aspect 9 is the method of aspect 8, where entering the RS valid state based on the second set of measurements being accurately measured further includes: entering the RS valid state based on the second set of measurements being accurately measured during an entirety of the observation period.

Aspect 10 is the method of any of aspects 1-9, further including: receiving, from the network node, a configuration of a quantity of consecutive measurements for the RS suspend state; and performing the second set of measurements for the quantity of consecutive measurements.

Aspect 11 is the method of aspect 10, where entering the RS valid state based on the second set of measurements being accurately measured further includes: entering the RS valid state based on the second set of measurements being accurately measured for all of the quantity of consecutive measurements.

Aspect 12 is the method of any of aspects 1-11, where performing the second set of measurements based on the set of RSs further includes: performing the second set of measurements based on the set of RSs and a second set of RSs.

Aspect 13 is the method of any of aspects 1-12, where the first set of measurements is associated with a first periodicity and the second set of measurements is associated with a second periodicity, and further including: receiving, from the network node, information indicative of the first periodicity and the second periodicity.

Aspect 14 is the method of any of aspects 1-13, where a first power consumption associated with the first set of measurements and a second power consumption associated with the second set of measurements are different by less than a power consumption threshold.

Aspect 15 is the method of any of aspects 1-14, further including: entering the valid state based on a reselection of a serving cell or movement to a new area.

Aspect 16 is the method of any of aspects 1-15, where the configuration of the suspend timer and a configuration associated with an observation period for the RS suspend state or a quantity of consecutive measurements for the RS suspend state is associated with a particular cell, a particular group of cells, or an area associated with the network node.

Aspect 17 is an apparatus for wireless communication at a device including at least one memory and at least one processor coupled to the at least one memory and, based at least in part on information stored in the at least one memory, the at least one processor is configured, individually or in combination, to implement any of aspects 1 to 16.

Aspect 18 is the apparatus of aspect 17, further including one or more transceivers or one or more antennas coupled to the at least one processor.

Aspect 19 is an apparatus for wireless communication at a device including means for implementing any of aspects 1 to 16.

Aspect 20 is a computer-readable medium (e.g., a non-transitory computer-readable medium) storing computer executable code, where the code when executed by at least one processor causes the at least one processor to implement any of aspects 1 to 16.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, a configuration of a set of reference signal (RS) resources for transmission during a radio resource control (RRC) non-connected state and a suspend timer associated with the set of RS resources;
enter an RS valid state based on the reception of the configuration;
perform a first set of measurements based on a set of RSs associated with the configuration;
enter an RS suspend state based on the set of RSs being inaccurately measured;
perform a second set of measurements based on the set of RSs; and
enter the RS valid state based on the second set of measurements being accurately measured before an expiration of the suspend timer.

2. The apparatus of claim 1, wherein the at least one processor, individually or in any combination, is further configured to:
receive, from the network node, a configuration of an observation period for the RS valid state; and
perform the first set of measurements during the observation period.

3. The apparatus of claim 2, wherein to enter the RS suspend state based on the set of RSs being inaccurately measured, the at least one processor, individually or in any combination, is configured to:
enter the RS suspend state based on the set of RSs being inaccurately measured during an entirety of the observation period.

4. The apparatus of claim 1, wherein the at least one processor, individually or in any combination, is further configured to:
receive, from the network node, a configuration of a quantity of consecutive measurements for the RS valid state; and
perform the first set of measurements for the quantity of consecutive measurements.

5. The apparatus of claim 4, wherein to enter the RS suspend state based on the set of RSs being inaccurately measured, the at least one processor, individually or in any combination, is configured to:
enter the RS suspend state based on the set of RSs being inaccurately measured for all of the quantity of consecutive measurements.

6. The apparatus of claim 4, wherein the at least one processor, individually or in any combination, is further configured to:
re-perform the first set of measurements for the quantity of consecutive measurements based on at least one measurement of the quantity of consecutive measurements being inaccurately measured.

7. The apparatus of claim 1, wherein the at least one processor, individually or in any combination, is further configured to:
receive, from the network node, a configuration of a validity timer associated with the RS valid state;
enter an RS invalid state based on an expiration of the validity timer; and
transmit, to the network node, a request for an updated configuration of RSs.

8. The apparatus of claim 1, wherein the at least one processor, individually or in any combination, is further configured to:
receive, from the network node, a configuration of an observation period for the RS suspend state; and
perform the second set of measurements during the observation period.

9. The apparatus of claim 8, wherein to enter the RS valid state based on the second set of measurements being accurately measured, the at least one processor, individually or in any combination, is further configured to:
enter the RS valid state based on the second set of measurements being accurately measured during an entirety of the observation period.

10. The apparatus of claim 1, wherein the at least one processor, individually or in any combination, is further configured to:
receive, from the network node, a configuration of a quantity of consecutive measurements for the RS suspend state; and
perform the second set of measurements for the quantity of consecutive measurements.

11. The apparatus of claim 10, wherein to enter the RS valid state based on the second set of measurements being accurately measured, the at least one processor, individually or in any combination, is configured to:
enter the RS valid state based on the second set of measurements being accurately measured for all of the quantity of consecutive measurements.

12. The apparatus of claim 1, wherein to perform the second set of measurements based on the set of RSs, the at least one processor, individually or in any combination, is configured to:
perform the second set of measurements based on the set of RSs and a second set of RSs.

13. The apparatus of claim 1, further comprising one or more transceivers or one or more antennas coupled to the at least one processor, wherein the first set of measurements is associated with a first periodicity and the second set of measurements is associated with a second periodicity, and wherein the at least one processor, individually or in any combination, is further configured to:
receive, from the network node via the one or more transceivers or the one or more antennas, information indicative of the first periodicity and the second periodicity.

14. The apparatus of claim 1, wherein a first power consumption associated with the first set of measurements and a second power consumption associated with the second set of measurements are different by less than a power consumption threshold.

15. The apparatus of claim 1, wherein the at least one processor, individually or in any combination, is further configured to:
enter the valid state based on a reselection of a serving cell or movement to a new area.

16. The apparatus of claim 1, wherein the configuration of the suspend timer and a configuration associated with an observation period for the RS suspend state or a quantity of consecutive measurements for the RS suspend state is associated with a particular cell, a particular group of cells, or an area associated with the network node.

17. A method of wireless communication at a user equipment (UE), comprising:
receiving, from a network node, a configuration of a set of reference signal (RS) resources for transmission during a radio resource control (RRC) non-connected state and a suspend timer associated with the set of RS resources;
entering an RS valid state based on the reception of the configuration;
performing a first set of measurements based on a set of RSs associated with the configuration;
entering an RS suspend state based on the set of RSs being inaccurately measured;
performing a second set of measurements based on the set of RSs; and
entering the RS valid state based on the second set of measurements being accurately measured before an expiration of the suspend timer.

18. The method of claim 17, further comprising:
receiving, from the network node, a configuration of an observation period for the RS valid state; and
performing the first set of measurements during the observation period.

19. The method of claim 18, wherein entering the RS suspend state based on the set of RSs being inaccurately measured further comprises:
entering the RS suspend state based on the set of RSs being inaccurately measured during an entirety of the observation period.

20. A computer-readable medium storing computer executable code at a user equipment (UE), the code when executed by at least one processor causes the at least one processor to:
receive, from a network node, a configuration of a set of reference signal (RS) resources for transmission during a radio resource control (RRC) non-connected state and a suspend timer associated with the set of RS resources;
enter an RS valid state based on the reception of the configuration;
perform a first set of measurements based on a set of RSs associated with the configuration;
enter an RS suspend state based on the set of RSs being inaccurately measured;
perform a second set of measurements based on the set of RSs; and
enter the RS valid state based on the second set of measurements being accurately measured before an expiration of the suspend timer.
